(19) United States
(12) Patent Application Publication
(10) Pub. No.: US 2003/0057108 A1
(43) Pub. Date: Mar. 27, 2003

(54) DEVICE AND METHOD FOR ACCELERATED HYDRATION OF DRY CHEMICAL SENSORS

(76) Inventor: RAMAMURTHI SRIDHARAN, ANN ARBOR, MI (US)

Correspondence Address: TESTA, HURWITZ & THIBEAULT, LLP, HIGH STREET TOWER, 125 HIGH STREET, BOSTON, MA, 02110, US

(21) Appl. No.: 09/549,968

(22) Filed: Apr. 14, 2000

(51) Int. Cl. G01N 27/327; G01N 27/333

(52) U.S. Cl. 205/775; 205/778; 204/402; 204/416; 204/409; 204/403.01

(57) ABSTRACT

A system and method for rapid hydration and reduced out-of-warm-up baseline drift for chemical, electrochemical and enzyme sensors.

### CROSS-REFERENCE TO RELATED APPLICATIONS

This application claims priority to and is based on U.S. provisional patent application serial No. 60/170,136, filed Dec. 10, 1999.

### FIELD OF THE INVENTION

This invention relates to an electrode or electrochemical sensor system for measuring certain characteristics of an aqueous sample such as a body fluid or a blood sample and more particularly to such an apparatus including a thermal block assembly for accelerating hydration and calibration of the sensors, and to methods of use thereof.

### BACKGROUND OF THE INVENTION

In a variety of clinical situations it is important to measure certain chemical characteristics of the patient's blood such as pH; the concentration of calcium, potassium, chloride, and sodium ions; hematocrit; the partial pressure of O₂, and CO₂; and the like. These situations range from a routine visit of a patient in a physician's office to monitoring of a patient during open-heart surgery. The required speed, accuracy, and other performance characteristics vary with each situation.

Typically, systems which provide blood chemistry analysis are stand-alone machines or are adapted to be connected to an extracorporeal shunt or an ex vivo blood source such as a heart/lung machine used to sustain a patient during surgery. Thus, for example, small test samples of ex vivo blood can be diverted off-line from either the venous or arterial flow lines of a heart/lung machine directly to a chamber exposed to a bank of micro-electrodes which generate electrical signals proportional to chemical characteristics of the real time flowing blood sample.

The micro-electrodes which generate the electrical signals are generally stored dry. Such sensors generally have an inner salt layer covered by a polymeric membrane. For the sensors to become functional, the inner salt layer must be hydrated to form the internal solution of electrode contact. The hydration process occurs through the permeation of water through the polymeric membrane, mostly in the vapor form. This generally involves soaking the electrode sensors in an aqueous electrolyte solution, usually a calibrating solution, until the sensors are sufficiently hydrated. Hydration of the sensors is a very slow process, usually taking several hours for the physiochemical equilibrium of hydration to complete. Moreover, hydration of the dry chemical sensors causes a drift of the baseline response of the sensors which affects the sensor performance. Additional time is therefore required before the device is ready for use, and more frequent calibrations of the device are required to reduce imprecise results.

The time required to hydrate dry chemical sensors and stabilize baseline drift is lengthy. In the context of clinical applications, this additional time reduces the sensors' availability and leads to more rapid consumption of calibrating reagents. Moreover, the faster consumption of calibrating reagents reduces the use-life of the sensor. Therefore, it is desirable to minimize the hydration time and reduce the baseline drift of dry chemical sensors used in blood analysis machines.

### SUMMARY OF THE INVENTION

One objective of the present invention is to provide a system and method for rapid hydration of a sensor. Rapid hydration of the sensor reduces the time required to achieve a functional sensor. Another objective of the invention is to provide a system and method to reduce baseline drift after the sensor warm-up period.

In one aspect of the present invention, a system for rapid hydration includes at least one sensor, a calibrating solution in contact with the sensor, and a heater for heating the sensor and the calibrating solution to an elevated temperature for a first period of time, then cooled to a lower temperature for a second period of time. The heater may utilize a thermoelectric device that applies the Peltier-effect, electrical resistance, or any other known means for controlled heating and/or cooling. The sensors may be chemical, electrochemical, or enzyme sensors. In preferred embodiments, the sensors are incorporated within a card or cartridge that can be inserted or removed from the system.

In some embodiments of the invention, the heating of the sensor in contact with the calibrating solution is carried out in a first thermal block assembly that is capable of raising the temperature of the sensor and calibrating solution to a temperature higher than the temperature used for sample analysis. After a specified time period, the sensor in contact with the calibrating solution is transferred to a second thermal block assembly which is set to maintain the temperature of the sensor at a cooler temperature, for example, at 37° C. In these embodiments, two thermal blocks are used.

In a particular embodiment of the invention, the sensor in contact with the calibrating solution is inserted into a single thermal block assembly with a heating element that heats the sensor and the calibrating solution in contact with the sensor to a temperature higher than the temperature used for sample analysis. The same thermal block assembly is used to lower the temperature of the sensor and calibrating solutions to the analytical temperature, for example, 37° C. Preferably, a thermal block is employed that can raise and lower the temperature by thermoelectric principles, such as the Peltier-effect. Thus, in this embodiment of the invention, only one thermal block assembly is required to raise and lower temperature of the calibrating solution and the at least one sensor.

In another aspect of the invention, a method for hydrating a sensor includes the steps of providing a sensor, contacting the sensor with a calibrating solution such as an electrolyte solution, exposing the sensor and calibrating solution to an elevated temperature for a time period of, for example, 12-30 minutes, preferably, minutes, and reducing the sensor and the calibrating solution to a temperature less than the elevated temperature. The sensors can be dry chemical sensors, enzyme sensors, or electrochemical sensors. In some embodiments, the elevated temperature is about 55° C. to 75° C. In some embodiments, the lower temperature is in the range of about 15° C. to 45° C., preferably 37° C. In preferred embodiments, the sensor and the calibrating solution are exposed to the elevated temperature of about 60° to 65° C. for a time period of about 12 minutes, and then the sensor and the calibrating solution are exposed to the lowered temperature of 37° C. for 16-18 minutes until the sensor becomes ready for use and is maintained at 37° C. thereafter.

In all of the embodiments of the invention, at least one sensor is thermal cycled, and in a particular embodiment of the invention a plurality of sensors is thermal cycled.

The foregoing and other objects, aspects, features, and advantages of the invention will become apparent from the following description and from the appended claims.

### BRIEF DESCRIPTION OF THE DRAWINGS

FIG. 1 illustrates a diagram of the components of an electrochemical sensor apparatus including a sensor cartridge with a bank of sensors and a thermal block for accelerated hydration and calibration of the sensors.

FIG. 2 illustrates a reverse frontal view of the electrode card, partly fragmentary, of a cartridge embodiment of the invention.

FIG. 3 illustrates an embodiment of a pO₂ sensor.

FIG. 4 illustrates a frontal view of the electrode card contained in one embodiment of the cartridge.

FIG. 5 illustrates a sectional view taken on line 5-5 of FIG. 2.

FIGS. 6A-G illustrate the components of a thermal block assembly.

FIG. 7 graphically illustrates a plot of Na+ sensor output (mv) versus hours of use (Hr) for thermal cycled and non-thermal cycled sensors.

FIG. 8 graphically illustrates a plot of base line drift of Na+ sensor output (mV/hr) versus hours of use (Hr) for thermal cycled and non-thermal cycled sensors.

FIGS. 9A, 10A, 11A, 12A and 13A are graphical representations of baseline drift of sensor output versus time for Na⁺, K⁺, Ca⁺⁺, pH, and pCO₂ sensors, respectively, hydrated at 37° C. for 42 minutes and calibrated for 18 minutes before the system is ready for use.

FIGS. 9B, 10B, 11B, 12B and 13B are graphical representations of baseline drift of sensor output versus time for Na⁺, K⁺, Ca⁺⁺, pH, and pCO₂ sensors, respectively, hydrated at 65° C. for 15 minutes and calibrated for 18 minutes before the system is ready for use.

### DETAILED DESCRIPTION OF THE INVENTION

The present invention provides improved electrode or electrochemical sensor systems for measuring characteristics of aqueous samples including, but not limited to, blood, serum or other body fluids. Specifically, the invention is directed to such sensors in which the electrodes are manufactured or stored in a “dry” form which requires hydration before use. The sensor systems are improved in that they have reduced hydration times and baseline drift. In preferred embodiments of the invention, the sensor system is adapted to measure the unbound concentration or activity of blood gases (e.g., oxygen and carbon dioxide) ions (e.g., sodium, chloride, potassium and calcium) blood pH and hematocrit. Alternative embodiments of the invention may be adapted to measure alternative and/or additional factors such as glucose, lactate or other blood solutes.

Definitions

In order to more clearly and concisely point out and describe the subject matter which applicant regards as the invention, the following definitions are provided for certain terms used in the following description and claims.

As used herein, the term “electrode” refers to a component of an electrochemical device which makes the interface between the external electrical conductor and the internal ionic medium. The internal ionic medium, typically, is an aqueous solution with dissolved salts.

Electrodes are of three types, working or indicator electrodes, reference electrodes, and counter electrodes. A working or indicator electrode measures a specific chemical species, such as an ion. When electrical potentials are measured by a working electrode, the method is termed potentiometry. All ion-selective electrodes operate by potentiometry. When current is measured by a working electrode, the method is termed amperometry. Oxygen measurement is carried out by amperometry. A reference electrode serves as an electrical reference point in an electrochemical device against which electrical potentials are measured and controlled. In a preferred embodiment, silver-silver nitrate forms the reference electrodes. Other types of reference electrodes are mercury-mercurous chloride-potassium chloride or silver-silver chloride-potassium chloride. A counter electrode acts as a sink for the current path.

As used herein, the term “sensor” is a device that responds to variations in the concentration of a given chemical species in a sample, such as a body fluid sample. An electrochemical sensor is a sensor that operates based on an electrochemical principle and requires at least two electrodes. For ion-selective measurements, the two electrodes include an ion-selective electrode and a reference electrode.

As used herein, the term “ion selective electrode” generally refers to a silver wire coated with silver chloride in contact with a buffer solution containing a fairly stable chloride concentration (the inner solution). The buffer solution is covered with a polymeric ion-selective membrane that is in contact with the test solution. The ion selective membrane typically consists of a high molecular weight PVC, a plasticizer, an ionophore specific to a particular ion, and borate salt. The surface of the polymeric membrane is in contact with the test sample on one side and the inner buffer solution on the other side of the membrane.

As used herein, the term “dry electrochemical sensor” refers to the ion selective electrode, described above, and a reference electrode, described above. In the “dry chemical” embodiment, the ion-selective electrodes have the same configuration as described above, however, the inner solution containing chloride, is dried, i.e., dehydrated leaving a layer of dry salt. In order to function as an electrochemical sensor, the dried salt must be solubilized in water to obtain a buffer solution.

As used herein, the term “hydration” refers to the process of solubilizing the salts of a sensor's inner salt layer by the passage of water through the ion-selective outer polymeric membrane bounding one side of the inner salt layer, into the inner salt layer to form a solution. Hydration normally can be achieved by mere contact of the outside of the polymeric membrane and inner salt solution with an aqueous salt solution for a required duration.

As used herein, “thermal cycling” is the process by which the temperature of an electrochemical sensor, soaked in an aqueous salt solution, is raised to a specified elevated temperature for a specified length of time, and then lowered.

As used herein, the term “calibration” refers to the process by which the response characteristics of a sensor to a specific analyte are determined quantitatively. To calibrate a sensor, the sensor is exposed to at least two reagent samples, each reagent sample having a different, known concentration of an analyte. The responses, i.e., signals, measured by the sensor, relative to the concentrations of the analyte in the two different reagent samples, serve as reference points for measurements of the analyte in samples having unknown concentrations of the analyte.

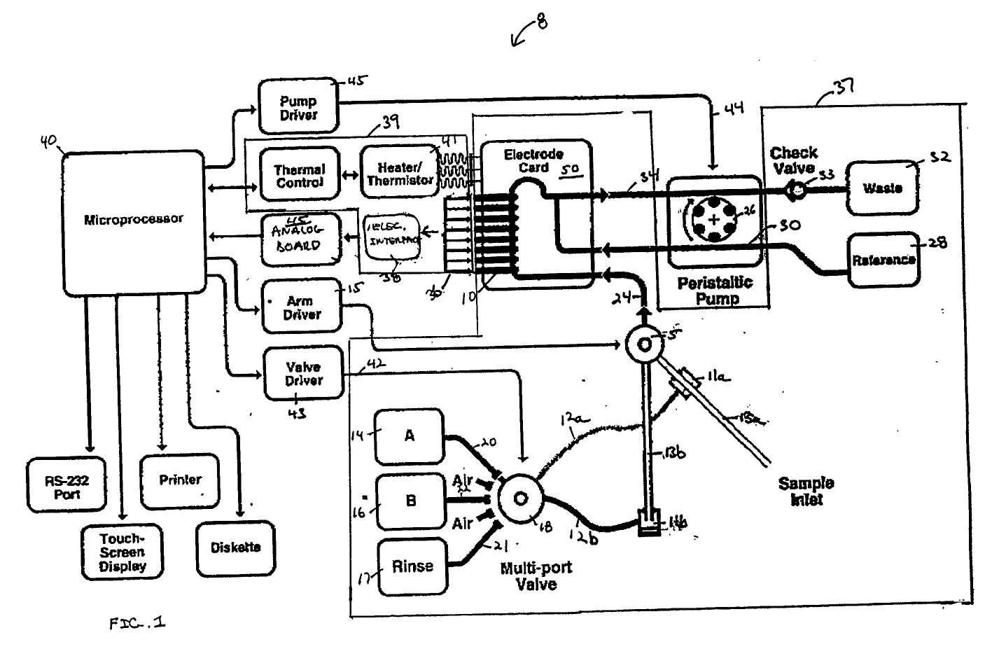

Referring to FIG. 1, the overall fluid analysis system 8 employs a sensor assembly, generally indicated at 10, incorporating a plurality of electrodes adapted to make electrical measurements on a blood sample introduced to the sensor assembly 10. Blood samples to be analyzed by the system are introduced through a sample inlet 13a. Blood samples are obtained by, for example, phlebotomy or are derived on a periodic basis from an extracorporeal blood flow circuit connected to a patient during, for example, open heart surgery. Blood samples may be introduced into the sample inlet 13a through other automatic means, or manually, as by syringe. The blood samples may be introduced as discrete samples.

The fluid analysis sensor assembly 8 incorporates two prepackaged containers 14 and 16 in a cartridge, each containing a calibrating aqueous solution having known values of the parameters to be measured by the system. The two calibrating solutions have different known values of each of the measured parameters to allow the system to be calibrated on a 2-point basis. For purposes of reference, the solution contained within the bag 14 will be termed Calibrating Solution A and the solution contained within the bag 16 will be termed Calibrating Solution B. Each of the bags 14 and 16 contains a sufficient quantity of its calibrating solution to allow the system to be calibrated a substantial number of times before the bags become empty. When the bags 14 and 16 containing the calibrating solutions are empty, the cartridge containing bags 14 and 16 must be replaced.

Referring to FIG. 1, the container 14 is connected to the input of a multi-position valve 18 through a flow line 20 and the container 16 is connected to a second input of the multi-position valve 18 through a flow line 22. A third container 17 contains a rinse solution and is connected to the input of the multi-position valve 18 through a flow line 21. The solution flow line 12 is the output of the multi-position valve 18 and is connected to the sample input line 13 through a stylus 11. Depending upon the position of the valve 18, the input lines 20, 21, 22 or air is open to the valve 18. Similarly, when the stylus is in a normal position (position 11b) of the sample input line 13b, line 12b is open to the sample input line 13b and allows passage of the calibrating, or rinse solution, or air through the sample input line 13b to the sensor assembly 10 through line 24, facilitated by the operation of the peristaltic pump 26. However, in a sample accepting mode (13a), line 12 is separated from the sample input line (position 12a) and the sample is introduced directly to the sensor assembly 10 through line 24, facilitated by the operation of the peristaltic pump 26.

The system also includes a fourth container 28, for a reference solution. The container 28 is connected to the sensor assembly by a flow line 30. The system further includes a fifth container 32 for waste, which receives the blood samples, the calibrating solutions and the reference solution after they have passed through the sensor assembly 10, via a flexible conduit 34 that has input from the sensor assembly 10.

Both the waste flow conduit 34 and the reference solution flow line 30 consist of or include sections of flexible walled tubing that pass through a peristaltic pump, schematically illustrated at 26. The pump compresses and strokes the flexible sections of the flow lines 30 and 34 to induce a pressured flow of reference solution from the container 28 to the electrode assembly 10 and to create a negative pressure on the waste products in flow line 34 so as to draw fluids in the flow line 24 through passages in the electrode assembly 10. This arrangement, as opposed to the alternative of inducing positive pressure on the blood and calibrating solutions to force them through the electrode assembly 10, avoids the imposition of unnecessary and possibly traumatic mechanical forces on the blood sample and minimizes possibilities of leaks in the electrode assembly.

The system including a number of essential components as heretofore described in a preferred embodiment of the present invention is contained in a disposable cartridge 37. A cartridge of a similar type is set forth in detail in U.S. Pat. No. 4,734,184, the entirety of the specification incorporated by reference herein. The present cartridge 37 contains a sensor card 50 which provides a low volume, gas tight chamber in which the blood sample is presented to electrochemical sensors, i.e., the pH, pCO₂, pO₂,Na⁺, Ca⁺⁺, and hematocrit sensors, together with the reference electrode collectively indicated as sensors 10, are integral parts of the chamber. Chemically sensitive, hydrophobic membranes typically formed from polymers, such as polyvinyl chloride, specific ionophores, and a suitable plasticizer, are permanently bonded to the chamber body. These chemically sensitive, hydrophobic membranes, described below in detail, are the interface between the sample or calibrating solutions and the buffer solution in contact with the inner (silver/silver chloride) electrode.

Included in the cartridge 37, are two solutions that allow for calibrations at high and low concentrations for all parameters except hematocrit, which calibrates at one level. In addition, the cartridge 37 also includes the rotor-for-sample inlet arm 5, the pump tubing 24, 30 and 34, the sampling stylus 11, a waste bag 32, the reference solution 28, the rinse solution 17, calibration solutions A 14 and B 16, the check valve 33, and tubes 12, 20, 21 and 22. Blood samples that have been analyzed are prevented from flowing back into the sensor card from the waste container 32 due to the presence of a one-way check 33 valve in the waste line 34. After use, the cartridge 37 is intended to be discarded and replaced by another cartridge.

Referring to FIG. 1, sensors are available as a bank of electrodes 10 fabricated in a plastic card 50 and housed in a disposable cartridge 37 that interfaces with a thermal block assembly 39 of a suitably adapted blood chemistry analysis machine. The thermal block assembly 39 houses the heating/cooling devices such as a resistive element or a Peltier-effect device, a thermistor 41 to monitor and control the temperature, the electrical interface 38 between the sensors in the plastic card 50 and the microprocessor 40 through the analog board 45. The analog board 45 houses analog-to-digital and digital-to-analog converters. The signal from the electrode interface 38 passes through the analog-to-digital converter, converted into digital form for the processor 40 to store and display. Conversely, the digital signals from the processor 40, for example, the polarization voltage for oxygen sensor, go through the digital-to-analog converter, converted into an analog form and fed to the sensors for control, through the electrode interface 38.

Upon insertion of the cartridge 37 into the blood chemistry analysis machine 8, the sensor card 10 fits into the heater block assembly 39, described in detail below, and the heating/cooling assembly regulated by the microprocessor 40 cycles the temperature of the sensor card 50 and the solution in contact with the sensors inside the sensor card 50 through a specific temperature for a specified duration. The heater block assembly 39 is capable of rapid heating and cooling by, for example, a thermoelectric device applying, for example, the Peltier-effect, monitored by a thermistor 41, all controlled by the microprocessor 40. Alternatively, the cartridge 37 may be transferred to a second heater block assembly maintained at a different temperature than the first heater block assembly. The sensors connect to the electrode interface 38 which select one of the plurality of electrical signals generated by the sensors and passes the electrical signal to the microprocessor 40 in the machine through an analog-to-digital converter into the analog board 45 where it is converted from analog to digital form, suitable for storage and display.

Referring to FIG. 1, the electrode assembly 10 has a number of edge connectors 36 in a bank which allow it to be plugged into a female matching connector 38 so that the electrodes formed on the assembly 10 may be connected to microprocessor 40 through the analog board 45. The microprocessor 40 is connected to the multiport valve 18 via a valve driver 43 by a line 42 and to the motor of the peristaltic pump 26 via a pump driver 45 by a line 44. The microprocessor 40 controls the position of the sample arm 5 through arm driver 15, and the position of the valve 18 and the energization of the pump 26 to cause sequences of blood samples and calibrating solutions to be passed through the electrode assembly 10. When the calibrating solutions from containers 14 and 16 are passed through the electrode assembly 10, the electrodes forming part of the assembly make measurements of the parameters of the sample and the microprocessor 40 stores these electrical values. Based upon measurements made during the passage of the calibration solutions through the electrode assembly 10, and the known values of the measured parameters contained within the calibrating solution from containers 14 and 16, the microprocessor 40 effectively creates a calibration curve for each of the measured parameters so that when a blood sample is passed through the electrode assembly 10 the measurements made by the electrodes can be used to derive accurate measurements of the parameters of interest. These parameters are stored and displayed by the microprocessor 40.

The microprocessor 40 is suitably programmed to perform measurement, calculation, storage, and control functions.

Calibrating Solutions

A preferred composition of calibrating solution A, prepared at 37° C. and at atmospheric pressure tonometered with 8% CO₂—N₂ gas, is as follows:

| | AMOUNT | |
|---|---|---|
| COMPOUND | (1 LITER BATCH SIZE) | |
| Dionized water | 1000 | g |
| MOPS (3-[N-morphollnopropanesulfonic acid) | 16.5 | g |
| Buffer | | |
| Sodium MOPS Buffer | 8.2 | g |
| Sodium Sulfite | 5.0 | g |
| Potassium Chloride | 0.17 | g |
| Calcium Chloride | 0.068 | g |
| Sodium Chloride | 2.76 | g |
| Sodium Bicarbonate | 1.26 | g |
| Proclin | 1.015 | g |
| HCI acid | 0.15 | g |
| Brij | 0.256 | g |
| (from a 25% solution as surfactant) | | |

This composition is effectively a blood facsimile and has the following parameters to be measured by the system (Radiometer).

| | PCO₂ | O₂ | | | Ca |
|---|---|---|---|---|---|
| pH | mmHg | mmHg | Na mmol/L | K mmol/L | mmol/L |
| 6.908-6.932 | 60.5-64.5 | 0 | 153.5-156.5 | 1.81-2.11 | 0.18-0.22 |

A preferred composition of calibration solution B, prepared at 37° C. and at 700 mmHg absolute pressure tonometered with 21% O₂-4% CO₂—N₂ gas, is as follows:

| | |
|---|---|
| COMPOUND | AMOUNT |

| | | |
|---|---|---|
| Dionized water | 1000 | g |
| MOPS (3[N-morpholinopropanesulfonic acid) Buffer | 6 | g |
| Sodium MOPS Buffer | 18.75 | g |
| Sodium sulfate | 3.75 | g |
| Magnesium Acetate | 1.07 | g |
| Potassium Chloride | 0.527 | g |
| Calcium Chloride | 0.535 | g |
| Sodium Chloride | 0.13 | g |
| Sodium bicarbonate | 1.932 | g |
| Proclin | 1.023 | g |
| HCI acid | 0.313 | g |
| Brij | 0.256 | g |
| (from a 25% solution as surfactant) | | |

This composition is effectively a blood facsimile and has the following parameters to be measured by the system (Radiometer).

| | PCO₂ | O₂ | Na | K | Ca |
|---|---|---|---|---|---|
| pH | mmHg | mmHg | mmol/L | mmol/L | mmol/L |
| 7.385-7.415 | 33.0-37.0 | 190-210 | 133-137 | 5.87-6.27 | 1.90-2.04 |

The compositions of the two calibrating solutions are chosen so that for each of the characteristics measured by the system a pair of values are obtained that are spaced over the range of permissible values that are measured by the system, providing a balanced 2-point calibration for the instrument.

The calibration compositions are prepared by premixing all of the constituents, with the exception of the calcium dihydrate salt, next tonometering the solution with oxygen and CO₂ mixed with nitrogen to produce the desired level of pH for the solution; then adding the calcium salt; and finally retonometering the solution to adjust for any variation in the gas levels which occurred during addition of the calcium salt.

The temperature and pressure at which the calibrating solutions are prepared and their method of packaging must be such as to preclude the possibility of dissolved gases going out of solution in the container, which would affect the concentration of gases in the calibrating solutions, and to minimize the tendency for gases to permeate through even the most impermeable materials practically obtainable. The calibration solutions are packaged with the solutions completely filling the containers, so that there is no head space, by evacuating the containers prior to filling in a manner which will be subsequently described.

By filling the calibration solution into an evacuated flexible wall container at elevated temperatures and subatmospheric pressure, the solution will not have any tendency at a lower use temperature to outgas and thus produce gas bubbles in the container. Were outgassing to occur, the concentrations of the gases in the solution would be affected, creating an inaccuracy in the calibration of the instruments. Similarly, we have found that it is important that the calibration solutions not be packaged at too low a pressure i.e., not below about 625 mm of mercury, because the absorptive capacity of the solution for gases conceivably increases as the packaging pressure decreases and below that pressure value the absorptive capacity of the solution may be sufficiently high that it will tend to draw gases in through the slight inherent permeability of even the most gas impervious flexible packaging material, over long periods of time. Accordingly, a packaging pressure in the range of 625-700 mm of mercury is preferred.

It is also useful to prepare a calibrating solution at a temperature in excess of its intended use temperature so that at the lower temperature there is less tendency for outgassing of the dissolved gases. This cooperates with the reduced pressure packaging to minimize the possibility of outgassing.

Calibration Solution A is prepared at a temperature above its intended use temperature at a controlled pressure close to atmospheric pressure. This solution contains no oxygen. The sodium sulfite in the solution serves to remove any residual oxygen from the prepared solution. Through use of elevated temperature (e.g., 37° C.) the solution may be prepared at about atmospheric pressure without any possibility of subsequent microbubbles within the container or gas transfer through the container when packaged in a zero head space flexible gas impervious container.

The envelopes which form the calibration solution bags are formed, for example, of rectangular sheets, heatsealed at the edges and heatsealed at one comer to an inlet stem of the valve 18 which is used for filling purposes. In the preferred embodiment illustrated, the bags 14 and 16 and the bag lines 20 and 22 are formed in a unitary cluster with the valve 18 so that gas phase dead space in the tubing lines is thereby avoided. In a preferred procedure for purging and filling the envelope bags, the envelope is first evacuated and then filled with CO₂. The CO₂ is then evacuated, the bag is filled with the prepared solution, and the solution is sealed in the container. This carbon dioxide gas purge cycle is performed, and repeated if necessary, so that gas, if any, left in the envelope during the final filling operation will be largely carbon dioxide. The calibrating solutions have a high absorptive capacity for carbon dioxide and accordingly any head space in the packages will be eliminated by absorption of the carbon dioxide after sealing of the packages. The bicarbonate-pH buffer systems of the calibration solution have a good buffering capacity for carbon dioxide so that the slight initial presence of gas phase carbon dioxide will not make any appreciable change in the concentration of carbon dioxide in the calibration solution.

The packaged calibration solutions have excellent stability and a long shelf life. When at use temperature and atmospheric pressure there is no possibility of any outgassing from the liquid to form gas bubbles within the container.

Reference Solution

The reference solution disposed in bag 28 is employed in the electrode assembly 10 as a supply source to a reference electrode to provide a liquid junction and thereby isolate the reference electrode from the varying electrochemical potential of the calibrating solution or the blood in a manner which will be subsequently described. In a preferred embodiment, the solution is 2 molar in potassium chloride solution and initially saturated with silver chloride. Thus, the reference solution is relatively dense compared to blood and calibration solution, being hypertonic. In other words, a density gradient exists between the reference solution and the less dense isotonic liquids. The solution also contains a surfactant such as Brij 35 (70 ul/l of solution, to minimize bubble formation) and sodium sulfite (0.16 molar). The sodium sulfite consumes any oxygen dissolved in the solution, keeping the solution unsaturated and thus preventing any formation of bubbles which would disrupt the operation of the device. The solution is prepared at room temperature and then cooled to a temperature below any reasonable storage temperature to allow the silver chloride to precipitate out. The solution is then filtered to remove the precipitate and is then packaged in a sealed flexible container with no head space. This technique assures that the concentration of silver chloride in the reference solution will be constant and independent of storage temperature.

Electrode Assembly

Referring to FIG. 1, during operation of the pump 26, the electrode assembly 10 receives a constant pulsating flow of the reference solution via line 30 and sequential, intermittent pulsating flows of either the blood sample or one of the two calibrating solutions via line 24. The assembly also provides a corresponding output of its waste products to a waste collection bag 32 via line 34.

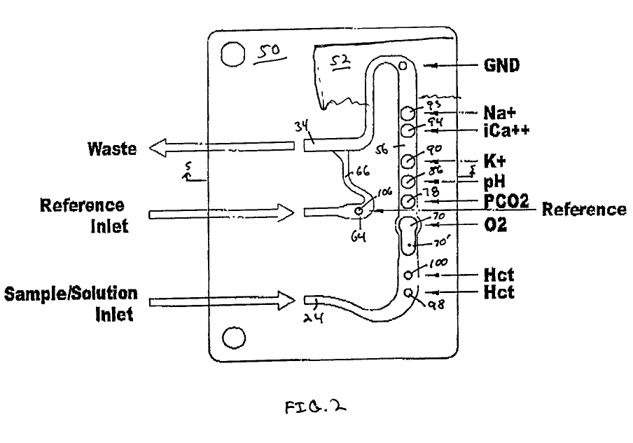

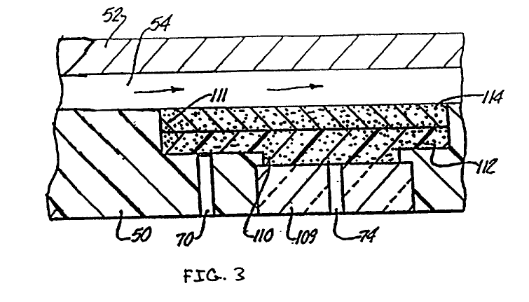

Referring to FIG. 2, by way of example, the electrode assembly in a preferred embodiment consists of a structurally rigid rectangular support or substrate 50 of polyvinylchloride having a rectangular aluminum (or other suitable material) cover plate 52 adhered to one of its surfaces. Cover plate 52 closes off the flow channels formed in one surface of the substrate 50 and also acts as a heat transfer medium for hydrating the sensors by thermal cycling, described below, and to maintain the fluids flowing through the electrode assembly 10, and the electrodes themselves, at a constant temperature during calibration and during measurement of relevant parameters in a patient sample. This may be achieved by measuring the temperature of the plate 52 and employing a suitable heating or cooling element e.g., a Peltier-effect device and thermistor 41 to maintain the temperature of the plate 52 at a desired temperature.

Referring to FIG. 2, a reference solution is introduced to a well 64, formed in the surface of the substrate 50 in the same manner as the other flow channels and similarly covered by the metal plate 52. The reference solution flow line 30 passes through an inclined hole in the well 64. The well 64 is connected to the output section 34 of the flow channel through a very thin capillary section 66 formed in the surface of the plastic substrate 50 in the same manner as the main flow channels. The capillary channel 66 is substantially shallower and narrower than the main flow channel; its cross section is approximately 0.5 sq. mm. Reference fluid pumped into the well 64 by the pump 26, via a line 30 (see also FIG. 1), fills the well, and is forced through the capillary section 66 where it joins the output stream of fluid passing through the main flow channel section 56 and then flows with it to the waste bag 32. The combined influence of its higher density described above and the capillarity of the flow channel 66 serves to minimize any possibility of calibrating solution or blood passing downward through the channel 66 to the well 64 and upsetting the electrochemical measurements.

As a blood sample or calibration solution quantity introduced into the flow channel 24 passes through the flow channel 56 to the output section 34, it passes over a number of electrodes as illustrated in FIG. 2.

Referring to FIGS. 1 and 2, the heat plate 52 abuts and forms one wall of the sample channel 56. The heat plate 52 is in contact with the Peltier-effect device of the thermal block assembly 39 described below. The thermal block assembly 39 is capable of changing and controlling the temperature of the heat plate 52 between 15° C. and 75° C. The temperature change and control is monitored by a thermistor 41 and regulated by the microprocessor 40. An internal digital clock of the microprocessor 40 controls time and can switch on and switch off the thermal block assembly 39 according to a preset program. Thus, microprocessor 40 controls the thermal block assembly 39, regulating the temperature setting and the duration of each set temperature of the heat plate 52.

The Electrodes

The order of assembly of the electrodes given below is only by way of example and is not intended to be limited to the order provided.

The Hematocrit Electrode Pair

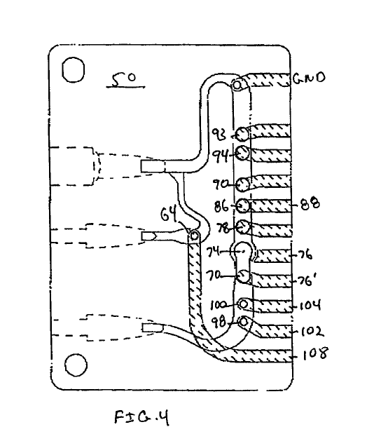

Referring to FIG. 2, a pair of gold wires 98 and 100 form electrodes for determining the hematocrit (Hct) of a sample based on its conductivity. The wires make contact with printed circuit edge connectors 102 and 104, respectively, best illustrated in FIG. 4.

The Oxygen Sensor

Referring to FIG. 2, the next sensor in the flow channel path 56 is the oxygen sensor with a self-contained two electrode configuration, best illustrated in FIG. 3. described in detail.

The Carbon Dioxide Electrode

Referring to FIG. 2, the next electrode 78 along the flow channel 56 measures the dissolved carbon dioxide in the blood or calibrating solution and works in combination with the pH electrode 86.

The pH Electrode

Referring to FIG. 2, next along the flow channel 56 is a pH sensing electrode best illustrated in FIG. 5 which includes a membrane 148 and a silver wire 86 staked or press-fitted through the thickness of the plastic 50 into the flow channel 56. Referring to FIG. 5, joined on the opposite side of the flow channel 56 is a pad printed conductor section 88 (also see FIG. 4) that forms an edge connector. The nature of this pH electrode will be subsequently described in detail.

The Potassium, Calcium and Sodium Ion Sensing Electrode

Next up the flow channel is a potassium sensing electrode 90, followed by a calcium sensing electrode 94 and a sodium sensing electrode 93 (each of the type shown in FIG. 5) including an active membrane and a staked silver wire and an associated edge connector.

The Ground

The ground illustrated in FIG. 2, is a silver wire inserted through the substrate 50. A ground serves as a common electric reference point for all electrodes. The ground may also serve as a counter electrode for the amperometric sensor system.

The Reference Electrode

Finally, as illustrated in FIG. 2, a silver wire 106 is staked through the thickness of the plastic substrate board 50 into the reference solution well 64 to act as a reference electrode. A printed circuit element 108, best illustrated in FIG. 4, extends along the back of the panel between the one end of this reference electrode and edge of the board to provide an edge connector.

The specific contruction and operation of the eletrodes will now be described in detail.

### SPECIFICS OF ION SELECTIVE ELECTRODES

The details of ion-selective electrodes are described in U.S. Pat. No. 4,214,968, incorporated by reference herein, and U.S. Pat. No. 4,734,184, incorporated by reference herein.

Ion-selective membranes of this type, which are also known as liquid membranes, constitute a polymeric matrix with a non-volatile plasticizer which forms the liquid phase in which an ion carrier or selector commonly referred to as an ionophore, which imparts selectivity to the membrane, is dispersed.

### ION-SELECTIVE MEMBRANE POLYMER

Polymers for use in the ion-selective membrane of the instant invention include any of the hydrophobic natural or synthetic polymers capable of forming thin films of sufficient permeability to produce, in combination with the ionophores and ionophore solvent(s), apparent ionic mobility thereacross. Specifically, polyvinyl chloride, vinylidene chloride, acrylonitrile, polyurethanes (particularly aromatic polyurethanes), copolymers of polyvinyl chloride and polyvinylidene chloride, polyvinyl butyral, polyvinyl formal, polyvinylacetate, silicone elastomers, and copolymers of polyvinyl alcohol, cellulose esters, polycarbonates, carboxylated polymers of polyvinyl chloride and mixtures and copolymers of such materials have been found useful. Films of such materials which include the ionophores and plasticizers may be prepared using conventional film coating or casting techniques and, as shown in the examples below, may be formed either by coating and film formation directly over the internal reference electrode or some suitable interlayer or by formation separately and lamination thereto.

### IONOPHORE

The ionophore used in the ion-selective membrane is generally a substance capable of selectively associating or binding to itself preferentially a desired specific alkali metal, alkaline earth, ammonium or other ions. The manner in which the ion becomes associated with the ionophore is not fully understood but it is generally thought to be a steric trapping phenomenon complexing by coordination or ion exchange. Suitable ionophores are more fully described below.

The selectivity of the electrode for a particular ion is due to the chemical nature of the ionophore and, thus, the use of different chemical components as the ionophore provides different membranes for use in ion-selective electrodes specific to different ions. Exemplary of such components are a large number of substances, some of them known to be antibiotics, which includes:

(1) valinomycin, a potassium-selective (over sodium), ionophore that imparts to a membrane constructed in accordance with this invention a potassium ion selectivity of the order of 10⁻⁴, and an ammonium ion selectivity (over sodium) of the order of 10⁻²;

(2) cyclic polyethers of various constitution which make the membrane selective to lithium, rubidium, potassium, cesium or sodium; and

(3) other substances having ion selectivity similar to valinomycin such as other substances of the valinomycin group, tetralactones, macrolide actins (monactin, nonactin, dinactin, trinactin), the enniatin group (enniatin A, B), cyclohexadepsipeptides, gramicidine, nigericin, dianemycin, nystatin, monensin, esters of monensin (especially methyl monensin for sodium ion-selective membranes), antamanide, and alamethicin (cyclic polypeptides).

There can also be used either a single substance or mixtures of substances of the formula:

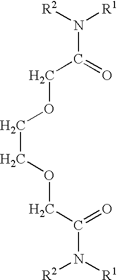

wherein:

I R¹: —CH₃ R²: —(CH₂)ₙ—COO—CH₂—CH₃

wherein n=1 or 10

II R¹:—CH₃ R²: —(CH₂)₆—CH₃

III R¹═R²: —CH₂—CH₂—CH₃

IV R¹: —CH₂—CH₂—CH₃ R²; —CH₂—C—(CH₃)₃

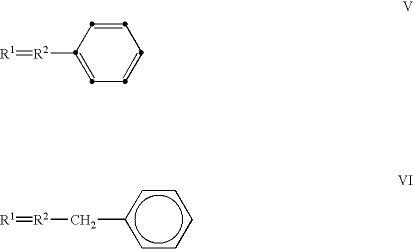

Other useful ionophores include tetraryl borates (especially tetraphenyl boron) and quarternary ammonium salts. Compounds such as trifluoroacetyl-p-alkyl benzenes are described in U.S. Pat. No. 3,723,281 issued Mar. 27, 1973, as ionophores for HCO₃.

Compounds of the following structural formulas are also useful as ionophores

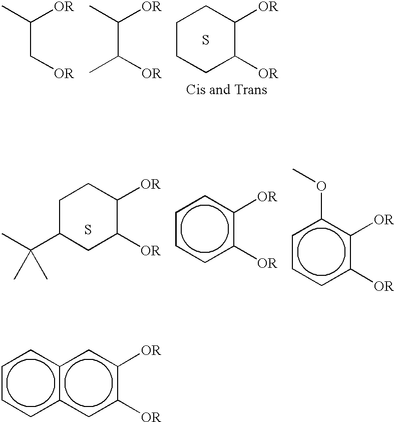

wherein:

(a) R═CH₂CON(CH₂CH₂CH₃)₂

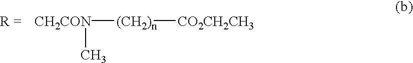

Useful calcium ion selective electrodes can be prepared using antibiotic A-23187 as the ionophore and tris(2-ethyl hexyl) phosphate, tri(m-tolyl)phosphate, or dioctyl phenyl phosphonate as the plasticizer.

Numerous other useful materials are described in the foregoing publications and patents, as well as other literature on this subject.

The concentration of ionophore in the membrane will, of course, vary with the particular carrier used, the ion undergoing analysis, the plasticizer, etc. It has generally been found, however, that ionophore concentrations of below about 0.1 g/m² of membrane assuming the membrane thicknesses preferred herein result in marginal and generally undesirable responses. Ionophore concentrations of between about 0.3 and about 0.5 g/m² are preferred. The ionophore can be incorporated at levels much higher than this; however, because of the cost of many of these materials, use of such levels is not economically sound.

The magnitude of the elevated temperature and the duration for which a membrane is exposed at that temperature to hydrate the membrane, may have a potential impact on the stability and integrity of the polymer matrix and of the ionophore discussed below. The inert matrix may degrade and the ionophore may not associate with the specific ion to be measured, when the matrix or inonophore is exposed to temperatures above 37° C. Should either the inert matrix fail by degrading or deforming at elevated temperatures, or should the ionophore fail to associate with the ion after exposure to elevated temperatures, the ion sensor will not function as intended.

### PLASTICIZER

The plasticizer provides ion mobility in the membrane and, although the ion-transfer mechanism within such membranes is not completely understood, the presence of a plasticizer is apparently necessary to obtain good ion transfer.

The plasticizer must, of course, be compatible with the membrane polymer and be a solvent for the ionophore.

The other highly desirable characteristic is that the plasticizer be sufficiently insoluble in water that it does not migrate significantly into an aqueous sample contacted with the surface of the membrane as described hereinafter. Generally, an upper solubility limit in water would be about 4.0 g/l with a preferred limit lying below about 1 g/l. Within these limits, substantially any solvent for the ionophore which is also compatible with the polymer may be used. It is also desirable that the ion plasticizer be substantially non-volatile to provide extended shelf-life for the electrode. Among the useful solvents are phthalates, sebacates, aromatic and aliphatic ethers, phosphates, mixed aromatic aliphatic phosphates, adipates, and mixtures thereof. Specific useful plasticizers include trimellitates, bromophenyl phenyl ether, dimethylphthalate, dibutylphthalate, dioctylphenylphosphonate, bis(2-ethylhexyl)phthalate, octyldiphenyl phosphate, tritolyl phosphate, tris(3-phenoxyphenyl) phosphate, tris(2-ethylhexyl) phosphate, and dibutyl sebacate. Particularly preferred among this class are bromophenyl phenyl ether and trimellitates for potassium electrodes using valinomycin as the carrier.

Specifically preferred from among the trimellitates are compounds of the formula:

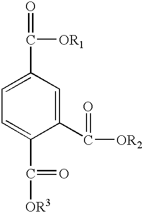

wherein R₁, R₂ and R₃ are alkyl groups of from 5 to 12 carbon atoms optionally such alkyl groups being the same or different.

When methyl monensin is used as the ionophore in a sodium ion-selective electrode, a preferred plasticizer is tris(3-phenoxyphenyl) phosphate.

A large number of other useful plasticizers permit assembly of electrodes of the type described herein and may be used in the successful practice of the instant invention.

The concentration of plasticizer in the membrane will also vary greatly with the components of a given membrane; however, weight ratios of plasticizer to polymer of between about 1:1 to about 5:2 provide useful membranes. The thickness of the membrane will affect electrode response as described in somewhat more detail below, and it is preferred to maintain the thickness of this layer below about 5 mils and preferably about 1 mil. As also described in greater detail below, the uniformity of thickness of the ion selective membrane plays an important role in the optimum utilization of electrodes of the type described herein. Thus, if maximum advantage in terms of storage capability and brevity of response time are to be obtained, the ion-selective membrane should be of relatively uniform thickness as defined above.

### SUPPORT

According to preferred embodiments, the ion-selective electrodes of the present invention include a support which may be comprised of any material capable of bearing, either directly or by virtue of some intervening adhesion-improving layer, the other necessary portions of the electrode which are described in detail hereinafter. Thus, the support may comprise ceramic, wood, glass, metal, paper or cast, extruded or molded plastic or polymeric materials, etc. The composition of the support carrying the overlying electrode components must be inert; i.e., it does not interfere with the indicating potentials observed as, for example, by reacting with one of the overlying materials in an uncontrolled fashion. Moreover, the composition of the support must withstand elevated temperatures to which the sensors will be exposed, for the time length required to hydrate and/or calibrate the sensors. In the case of porous materials such as wood, paper or ceramics, it may be desirable to seal the pores before applying the overlying electrode components. The means of providing such a sealing are well known and no further discussion of the same is necessary here.

According to a highly preferred embodiment of the present invention, the support comprises a sheet or film of an insulating polymeric material. A variety of film-forming polymeric materials are well suited for this purpose, such as, for example, cellulose acetate, poly(ethylene terephthalate), polycarbonates, polystyrene, polyvinylchloride, etc. The polymeric support may be of any suitable thickness typically from about 20-200 mils. Similarly thin layers or surfaces of other materials mentioned above could be used. Methods for the formation of such layers are well known in the art.

In certain cases, a separate and distinct support need not be provided. Such a case occurs when one or more layers of the electrode demonstrate sufficient mechanical strength to support the remaining portions of the electrode. For example, when a metal-insoluble metal-salt electrode is used as the internal reference electrode as described below, the metal layer may be in the form of a self-supporting foil. The metal foil serves as the support, an integral portion of the internal reference electrode, as well as a contact for the electrode.

### SPECIFICS OF THE PO₂ ELECTRODE

In one embodiment of the invention, the platinum wire 74, forming part of the oxygen electrode, is fixed in the center of an insulative glass disk 109 best shown in FIG. 3. The disk preferably has a thickness of approximately 40 mils while the board 50 may have a thickness of approximately 85 mils. The diameter of the glass disk is preferably about 100 mils.

A number of the glass disks with the embedded platinum wires are prepared by inserting a close-fitting length of platinum wire into the lumen of a glass capillary tube and then melting the tube so that it fuses to the wire. After the tube with the embedded wire hardens, the disks of given axial thickness are sliced off, e.g., by power saw means.

The glass disk is embedded in a recess formed through the thickness of the plastic board 50 so that one surface is flush with the surface of the board opposite to the cover plate 52 and the outer surface of the disk abuts a shoulder 110 formed around the bottom of the flow channel.

The glass disk is practically impervious to oxygen whereas the polyvinylchloride of the board 50 is relatively pervious. The glass disk thus protects the platinum electrode 74 from the gas so that only its distal end that faces the flow channel is active.

The upper surface of the silver electrode 70 is coated with a thin film of silver chloride preferably by filling the well with a potassium chloride solution and passing an electric current through the solution and electrode to plate or anodize a thin film of silver chloride on the electrode end.

The flow channel section 54 is depressed or increased in depth in the area of the oxygen electrode elements 70 and 74 to form a well 111. In fabricating the electrode, the glass disk 109 is inserted in place against the shoulder 110 and a two layer permeable membrane (covering the glass disk) is formed in the well so that its upper surface is substantially flush with the flow channel. The bottom hydratable layer 112 which is a critically important layer is a dried or substantially dried residue remaining after solvent removal from, or dehydration of, a solution of a hygroscopic electrolyte. The membrane may be conventional in this regard and may use known components (such as hydrophilic polymeric film-forming materials) and methods of preparation. The membrane is a hydratable membrane as broadly defined by Battaglia et al., U.S. Pat. No. 4,214,968, incorporated by reference herein. A preferred and hygroscopic electrolyte for the hydratable layer is a dried residue remaining after solvent removal from an aqueous solution comprising hydratable saccharide or polysaccharide and an electrolyte such as KCl. For best results, one uses a solution of hydratable saccharide and potassium chloride, preferably a small amount of sucrose (e.g., 0.6 g.) in 4.4 ml. of 0.0005M aqueous potassium chloride or an approximation or equivalent of such solution. This aqueous solution is dispersed into the well as a layer and the layer is allowed to desiccate or dry to form a dehydrated thick film. After this bottom layer 112 dries, the upper, water-and-gas permeable hydrophobic layer 114 is formed, using a film-formed polymeric membrane binder as defined by U.S. Pat. No. 4,214,968. For best results, this is done by introducing a permeable hydrophobic membrane forming solution, preferably a solution of a polymer such as polyvinylchloride, a suitable plasticizer such as bis(2-ethylhexyl)phthalate, and a solvent, preferably tetra-hydrofuran (THF). The solvent is then removed. When and as the solvent evaporates, a residual membrane is formed that is permeable to oxygen and water.

In use, for equilibrium, when a calibrating solution is made to dwell in the channel, water passes by permeation through the upper layer 114 to the lower layer 112 where it causes hydration of the lower layer 112 to form an aqueous solution. This hydration process from a non-conductive dry state to an electrochemically conductive stabilized hydrated state, can be accelerated by soaking the sensors in an electrolyte solution, such as the calibrating solutions described above, and thermally cycling the sensors through an elevated temperature higher than that of normal use. For example, the sensors are soaked in calibrating solution B at a temperature between 55° C. to 75° C. for 15 minutes, and then cooled to 37° C. The calibration cycles start as soon as the temperature reaches 37° C. In a particular embodiment, the sensors are soaked in a calibrating solution at a temperature of 65° C. for 12 minutes, and then cooled to 37° C. The calibration cycles start as soon as the temperature returns to 37° C.

Concerning the amperometric function of the electrode in operation, a negative potential relative to the silver electrode 70 is applied to the platinum wire 74 by the processor 40 which lessened potential serves to reduce any oxygen reaching its end and thereby produces an electrical current proportional to the oxygen diffusion through the layer 112. The hydrated layer 112 affords a reproduceably reliable conductive flow path between the platinum electrode and the silver electrode 70 to provide a polarization potential between the platinum and the solution in the hydrated layer. The resulting current flow is measured and is proportional to the oxygen concentration in the test fluid being monitored.

Advantageously, since the active layer is dehydrated prior to use, the electrode (either alone or in an assembly with other electrodes as in a bank or cartridge bank) can be stored indefinitely. Unlike conventional Clark electrodes and of major importance, the electrode is inactive until required and is then self-activating such that under normal use conditions in the water contained in the equilibrating/calibrating solution, the permeability of its upper layer to water allows water thus permeating to cause hydration of the lower level to render it fully and reproduceably active. This electrode structure is also advantageous when compared to the conventional Clark electrode in that it does not require an assembly of discrete mechanical components. It is a durable, single pre-assembled structure that is inherently small in size, inexpensive to manufacture, and requires no maintenance.

### pCO₂, pH, POTASSIUM, SODIUM AND CALCIUM ION SENSING ELECTRODES

The electrodes, best illustrated generally in FIG. 2, connecting the silver wires 78, 86, 90, 93, and 94 which sense pCO₂, pH, potassium, sodium and calcium activities, respectively, are similar in construction. The difference is in the composition of the membrane layers. A typical ion-selective electrode is illustrated in FIG. 5. Each has a bead or an inner salt layer 152, which upon hydration forms the inner solution layer. This layer is in contact with the thin film of silver/silver chloride layer 154 obtained by anodization of the top of the silver wires. The outer layer 148 is essentially the polymeric ion-selective membrane layer. This layer is formed over the dried salt residue of the inner layer in a shallow well 150 as a dry residue remaining after the solvent removal from a matrix of a permeable hydrophobic membrane forming solution such as a solution containing polyvinylechloride, a plastericizer, an appropriate ion-sensing active ingredient and a borate salt. The outer membrane is applied as a solution, typically in Tetrahydrofuran (THF) in a small droplet. Once the solvent evaporates, the membrane is formed and is bonded to the plastic card. In the case of pH and pCO₂ electrodes, the ion-selective active ingredient may be tridodecylamine (TDDA) or a suitable pH sensing component. For the potassium electrode, a monocyclic antibiotic such as valinomycin or other suitable kallepheric substance may be used as the active ingredient. The calcium electrode employs a calcium ion-selective sensing component as its active ingredient such as 8,17-dimethyl-8,17-diaza-9,19-dioxo-11,14-dioxo-tetracosane or other suitable calcium sensitive selective substance. The sodium electrode employs methyl monensin ester or any other suitable sodium sensitive active ingredient. The sodium, potassium and calcium electrodes use a buffer salt like MES (2-[N-morpholino]ehtansulphonic acid) along with the respective chloride salts for their inner solution.

pH and pCO₂ electrodes share the same outer layers, while their inner layers differ significantly. The internal layer for pH uses a strong buffer, for example, MES buffer, while that for CO₂ electrode use a bicarbonate buffer.

All ion-selective electrodes, except CO₂ electrode, operate through the measurement of the potential between the ion-selective electrode and the reference electrode 106 (FIG. 2), the change in potential is directly proportional to the change in the logarithm of the activity of the measured ion.

The CO₂ sensor is a combination of CO₂ and pH electrodes working together. In function the potential between the CO₂ and pH electrode is measured. The outer surface of both electrodes respond to pH in the same manner and cancel each other. The inner surface of the pH membrane has a high buffer with constant pH and does not cause any change in the measured potential. However, for CO₂, the membrane is freely permeable to CO_{2,}, which dissolves in the bicarbonate buffer changing its pH. This causes a change in the potential response of the inner surface of the CO₂ membrane, which is the only change to the overall measured potential. Thus, the potential across the CO₂ and pH electrodes directly measures the variation in the CO₂ concentrations of the sample.

The process of hydrating the inner salt layer in these ion-selective electrodes is achieved by soaking the outer surface of the outer membranes in an aqueous salt solution, usually a calibrating reagent solution. The hydration, however, is a very slow process, as the water has to permeate through the hydrophobic outer membrane in the vapor form. Thermal cycling through high temperatures facilitates the process. During the process of thermal cycling, the composition and integrity of the membrane layers stay intact.

Hydration and calibration of the ion sensing electrodes are accomplished by steps similar to those described for the pO₂ electrode. Hydration from a dry state can be accelerated by soaking the sensors in an electrolyte solution, such as the calibrating solutions described above, and thermally cycling the sensors through an elevated temperature higher than that of normal use. For example, the sensors are soaked in calibrating solution B at a temperature between 55° C. to 75° C. for 15 minutes, and then cooled to 37° C. The calibration cycles start as soon as the temperature reaches 37° C. In a preferred embodiment, the sensors are soaked in a calibrating solution at a temperature of 65° C. for 12 minutes, and then cooled to 37° C. The calibration cycles start as soon as the temperature returns to 37° C.

Hematocrit Measurement

The hematocrit (Hct) measurement is made through a measurement of resistivity between gold wires 98 and 100. The sensor operates by measuring the resistivity of the solution or blood sample placed between the electrodes. Hematocrit is calculated as a function of resistivity using the Maxwell equation.

Reference Solution Operation

Referring to FIG. 2, as has been noted, the reference solution fills the well 64 where it contacts a silver wire 106 and is pumped through the capillary channel 66 to join the outlet of the main flow line. The reference solution is essentially a hypertonic solution of potassium chloride, with respect to the blood or the calibrating solutions and accordingly the domain of the reference electrode 106 constitutes a stable potential liquid junction formed between the reference electrode and the blood or calibrating solution, thereby establishing an environment that is independent of the ionic activity of the blood or calibrating solution.

Since the reference solution joins the main flow channel downstream from the electrodes, after the gas/electrolyte measurements have been made, it does not affect those measurements in any way. The reference solution is of high density and under pumping force must flow upward against gravity to the outlet. Thus, when the pump stops, as for electrode equilibration, the reference solution remains stationary in the reference well 64 and the capillary section 66 and tends not to diffuse into the calibrating solution or blood in the main flow channel. Thus, the capillary tube 66 due to the density gradient, acts as a one way valve allowing pumped reference solution to pass upwardly through the capillary but preventing unwanted reverse passage or mixing of the blood or calibrating solution into the reference well.

Heater Block Assembly

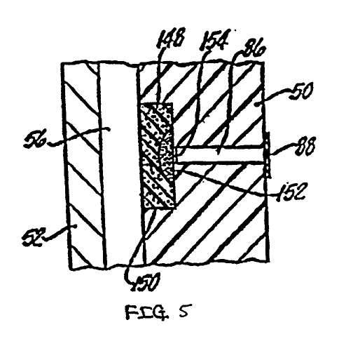

Referring to FIGS. 6A-6G, the heater block assembly 39 includes a thermoelectric device 230, a thermistor 41, an aluminum block featuring two aluminum shells 220a, 220b, electrode interface 156, metal plate 234, heat sink 236, electrical leads 229, 229′, 231, 231′, and cable 226. The aluminum block houses a sensor card 10 when the cartridge with the sensor card is inserted into the fluid analysis instrument 8.

Referring to FIG. 6A, the aluminum heater block assembly 39 includes two aluminum shells 220a, 220b which together form a socket 222 into which a sensor card 10 (not shown) can be inserted. As illustrated in FIG. 6B, electrical connection 156 located in socket 222, interfaces with the corresponding edge connectors in the sensor card illustrated in, for example, FIG. 4, to transmit signals from the sensors. A cable 226 connects the electrical connectors from the sensor card to a microprocessor 40 through an analog board 45 (See FIG. 1). A printed circuit board (analog board located before the processor) controls the sensors and measures sensor output. Printed circuit boards within this heater block assembly contain post amplifiers that amplify signals from the sensor in the sensor card. The output of the sensors are analog signals. The analog signals are converted to digital signals via a analog to digital converter, and the digital signals are transmitted to the microprocessor for storage, analysis, and display.

Referring to FIG. 6C, the interior surface 221 of aluminum shell 220b comes into contact with the metal plate 52 of a sensor cartridge 10 (see FIG. 2). On the external surface 223 of aluminum shell 220b, a thermistor 41 is located as illustrated in FIG. 6C. Extending from thermistor 41 are electrical connections 229, 229′ that connect the thermistor 41 to a microprocessor 40.

On top of the external surface 223 of aluminum shell 220b and over the thermistor 41, a thermoelectric device 230 illustrated in FIG. 6D, is positioned. Thermoelectric devices in the heater block assembly may use, for example, the Peltier-effect, to heat and cool the aluminum block. Electrical leads 231, 231′ supply programmed electrical current controlled by a microprocessor 40 to the thermoelectric device 230. The direction and duration of current is controlled by the microprocessor 40 and determines whether the thermoelectric device 230 overlying the aluminum shell 220b is in a warming or cooling mode. The temperature of the aluminum shell 220b is measured by thermistor 41 which transmits signals to microprocessor 40. Microprocessor 40 is programmed to transmit electrical signals to the thermoelectric device, depending on signals from the thermistor, to either heat or cool the aluminum shell 220b which in turn heats, cools or maintains the temperature of a sensor card inserted into socket 222. When current flows in the thermoelectric device 230 in the forward direction, the metal plate 220b is heated and this heat is transmitted to the sensor card in the socket 222. When current flows in the reverse direction, the metal plate 220b is cooled and the cooling effect is transmitted to the sensor card in the socket 222.

Referring to FIGS. 6D and 6E, the external surface 233 of the thermoelectric device 230 is in contact with a metal plate 234. The external surface 235 of metal plate 234 is in contact with a heat sink 236, illustrated in FIG. 6F.

The assembled cartridge socket 222, aluminum shell 220b, thermistor 41, thermoelectric device 230, metal plate 234, heat sink 236 and electrical leads 229, 229′ from the thermistor 41, and electrical leads 231, 231′ from the thermoelectric device 230 to the microprocessor 40 is illustrated in FIG. 6G.

In a preferred embodiment of the heater block assembly 39, the temperature for a sensor cartridge can be increased from about 37° C. to about 60° C. to 65° C. in one minute, maintained at 60° C. for 30 minutes with only 0.4° C. temperature fluctuation, and cooled to 37° C. from 60° C. in about two minutes.

Operation of the Assembly

Referring to FIG. 1, when the cartridge with the sensor assembly 10 and the filled bags 14, 16 and 28 are first used, the valve 18 is controlled to direct one of the calibration solutions into the sensor assembly so it entirely fills the flow channel. The pump is then stopped for a period of 10-45 minutes, preferably 12-15 minutes during which the dry chemical sensor electrodes are hydrated by thermal cycling, for example, from 37° C. to 65° C. and back to 37° C.

In one embodiment of the invention, the dry chemical electrode sensor assembly 10 is inserted into the fluid analysis system 8 and the valve 18 is controlled by microprocessor 40 to direct one of the calibration solutions into the sensor assembly 10. Thermal block assembly 39 is set at a temperature whereby the temperature of thermal plate 52 is sufficient to heat the calibrating solution in contact with the dry chemical sensor to a temperature in a range of 55° C. to 75° C., preferably 65° C., for 10-30 minutes, preferably 12 minutes. After the specified time period, the microprocessor 40 reverses current flow through the thermoelectric device to cool thermal plate 52. The sensor card and calibrating solution in contact with thermal plate 52 are cooled to 37° C. The temperature, controlled by the microprocessor 40, is maintained at 37° C. for the life of the cartridge 37. The calibration cycles start as soon as the temperature of the calibration solution reaches 37° C.

Enzyme Sensors

The above described thermal cycling process for rapid hydration and calibration of ion-sensors is also contemplated for enzyme sensors. Such enzyme sensors are useful for the analysis of solutes other than Na⁺, K⁺, Cl⁻, Ca⁺, gases other than PO₂, PCO₂, hematocrit and pH. For example, enzyme sensors are useful for analysis of glucose, or lactate, or other proteins in a body fluid sample such as blood. The following examples will serve to better demonstrate the successful practice of the present invention.

### EXAMPLE 1

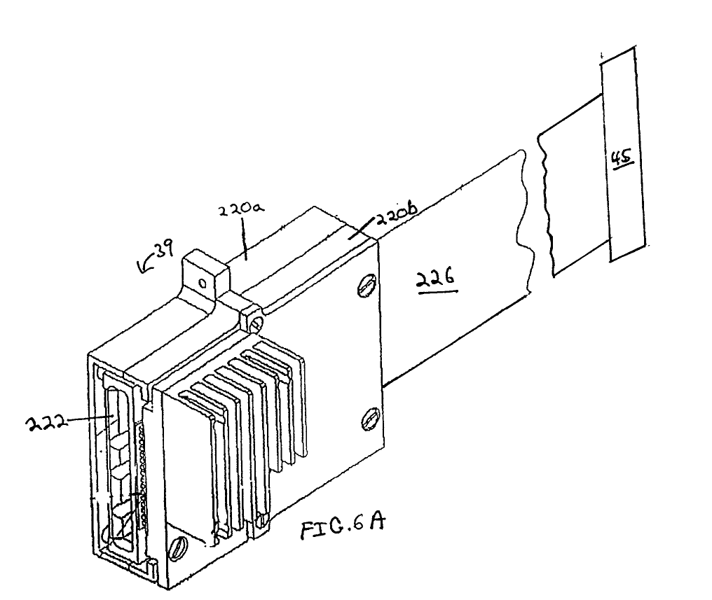

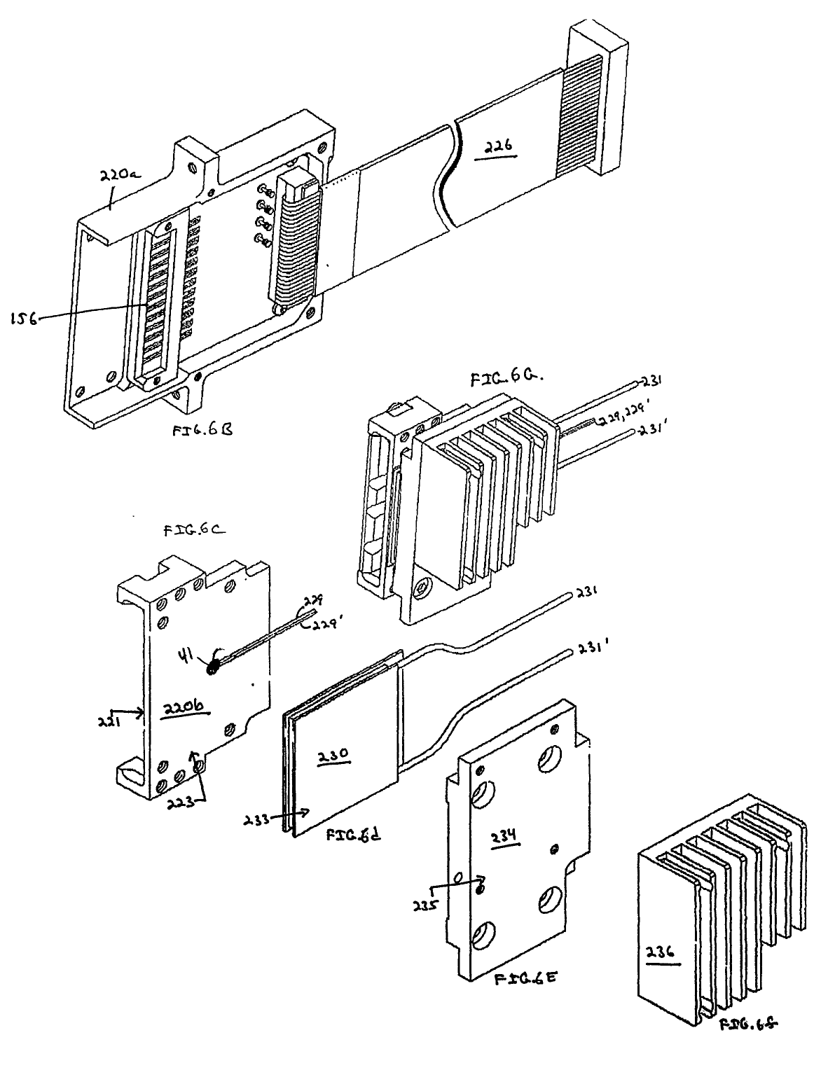

By the above described thermal cycling process, hydration of the sensor assembly electrodes is accelerated and a state of equilibrium in which baseline drift is minimal is rapidly achieved. Referring to FIGS. 7 and 8, the effect of initial thermal cycling during hydration of a sodium sensor is graphically displayed. Cartridge A, represented by plot A in FIGS. 7 and 8, was hydrated for 15 minutes in a calibrating solution heated to 70° C. Cartridge B, represented by plot B in FIGS. 7 and 8, was hydrated for 15 minutes in a calibrating solution heated to 37° C. Cartridges A and B were rapidly transferred to a fluid analyzing instrument to initiate the calibration cycle. As illustrated in FIGS. 7 and 8, cartridge A, hydrated for 15 minutes at 70° C. was closer to achieving baseline Na+ sensor output (mv) than cartridge B, hydrated for 15 minutes at 37° C., as early as a few minutes after the initiation of calibration and for as long as 6-8 hours after the calibration cycle began.

### EXAMPLE 2

The effect of time and temperature on the integrity of the plastic support card was analyzed. Plastic cards fully fabricated with silver paint and backing plates were stored in an oven set at 65° C., 70° C. and 75° C. for 36, 60 and 90 minutes. The geometric dimensions of the sensor card 10, i.e., length and width, were measured before exposure to elevated temperatures and following cool down. The results presented in Table I show that at temperatures as high as 70° C. for at least as long as 30 minutes, the integrity of the plastic support card is maintained.

TABLE I

| | | 65 C | | 70 C | | 75 C | |
|---|---|---|---|---|---|---|---|
| | | Length | Width | Length | Width | Length | Width |
| | | Inches | Inches | Inches | Inches | Inches | Inches |
| 30 minutes | Average | 0.0002 | 0.0000 | −0.0016 | −0.0007 | −0.0051 | −0.0078 |
| | Std. Dev. | 0.0004 | 0.0000 | 0.0010 | 0.0009 | 0.0006 | 0.0027 |
| 60 minutes | Average | 0.0002 | 0.0000 | −0.0023 | −0.0018 | −0.0091 | −0.0097 |
| | Std. Dev. | 0.0003 | 0.0007 | 0.0003 | 0.0006 | 0.0006 | 0.0038 |
| 90 minutes | Average | 0.0003 | −0.0003 | −0.0035 | −0.0006 | −0.0100 | −0.0100 |
| | Std. Dev. | 0.0003 | 0.0005 | 0.0007 | 0.0014 | 0.0009 | 0.0020 |

### EXAMPLE 3

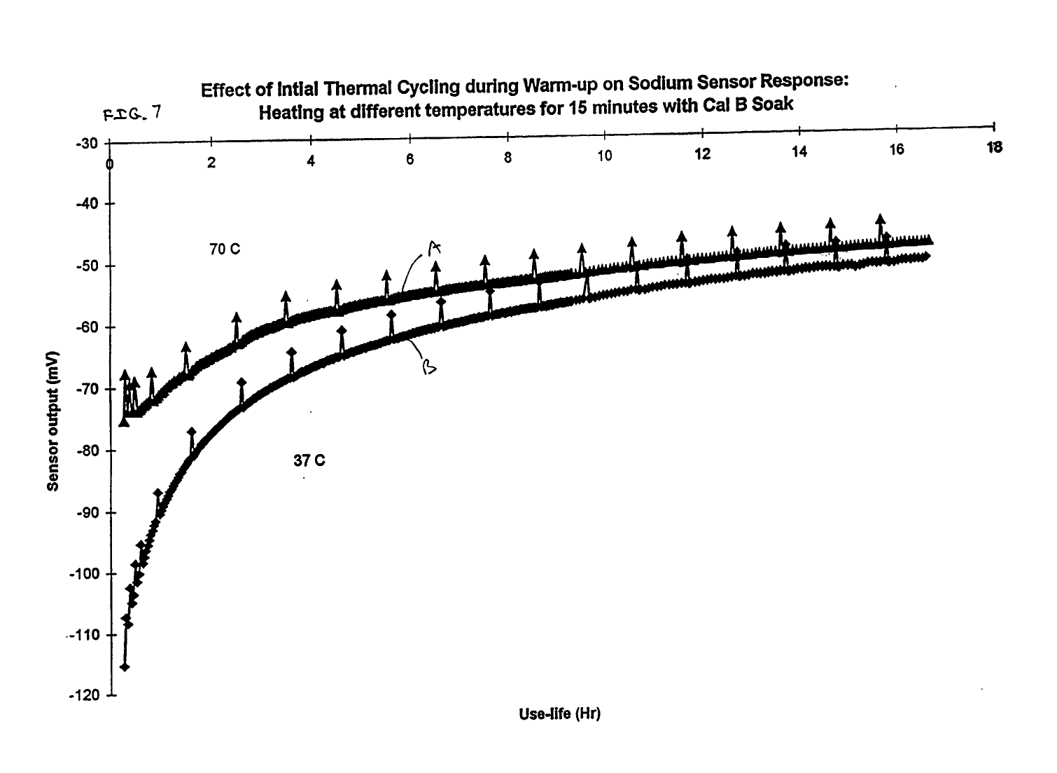

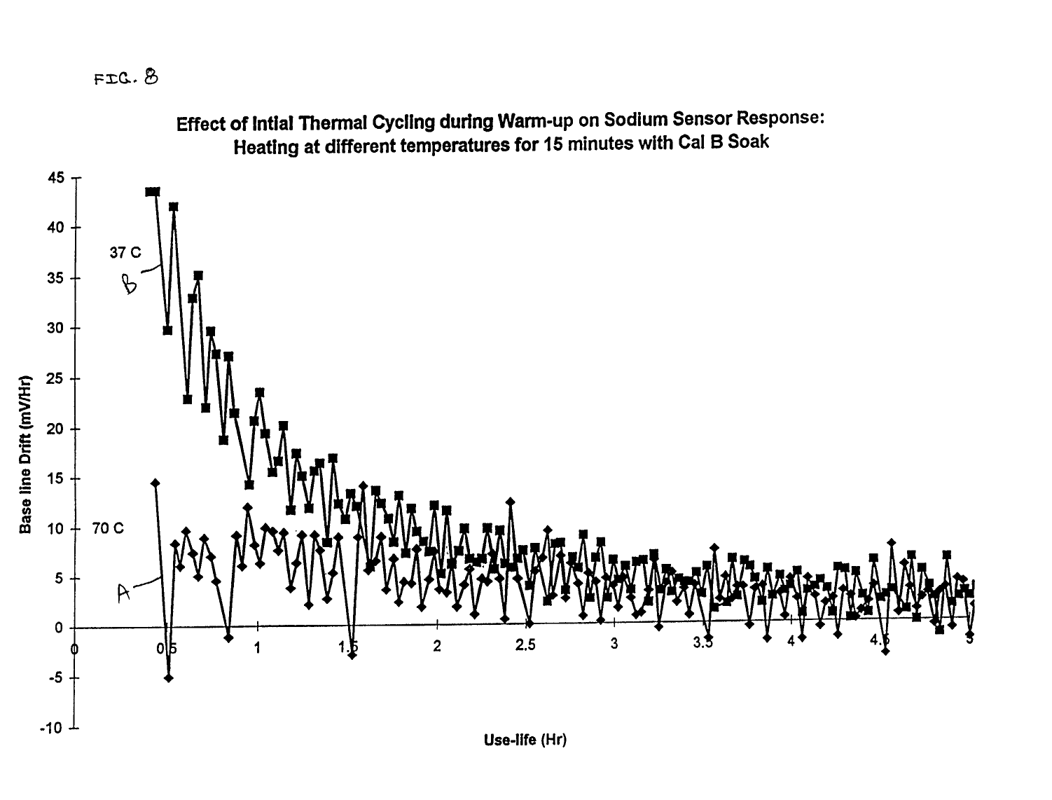

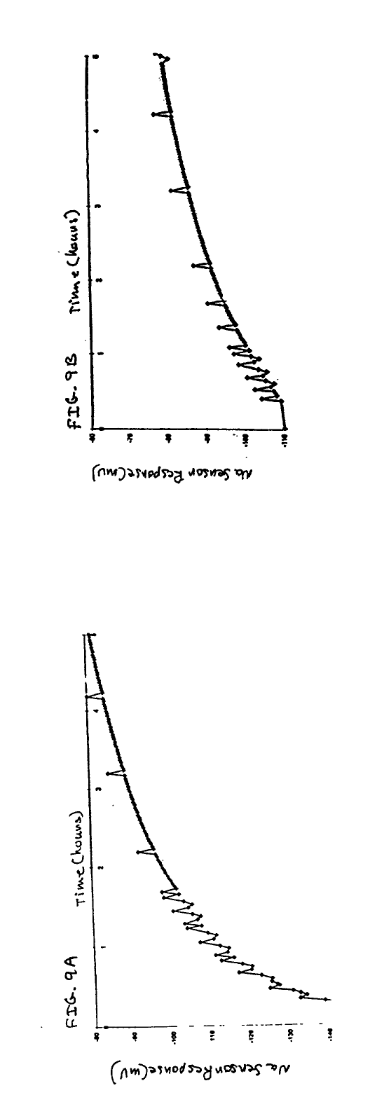

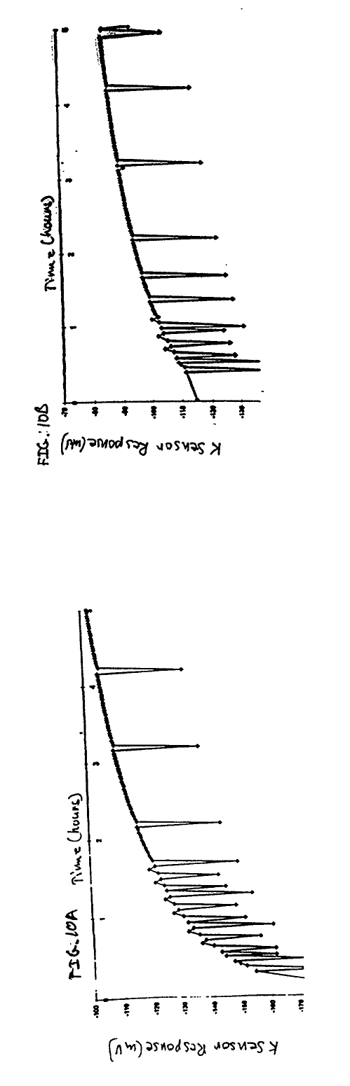

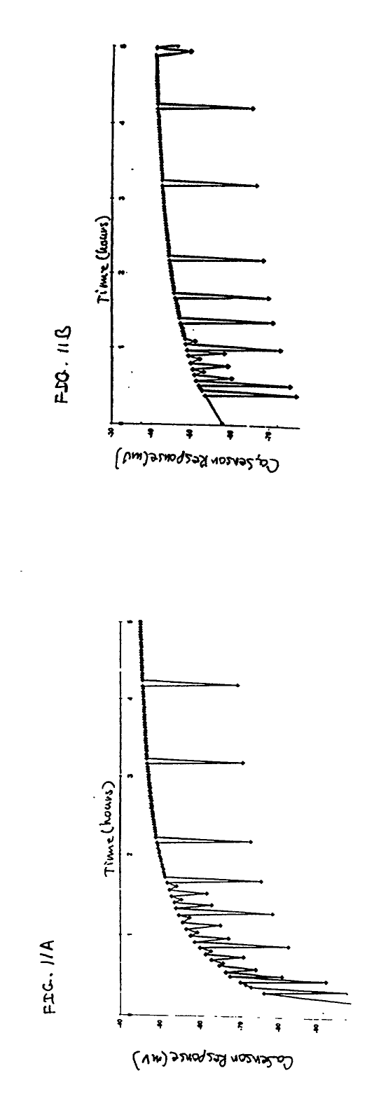

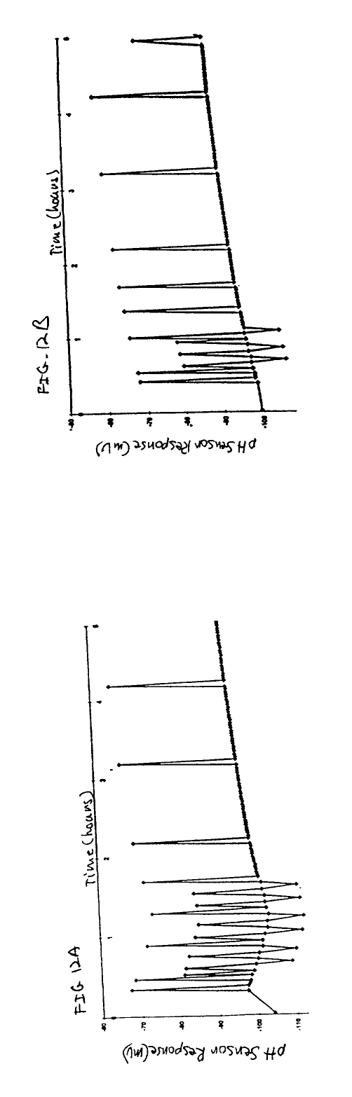

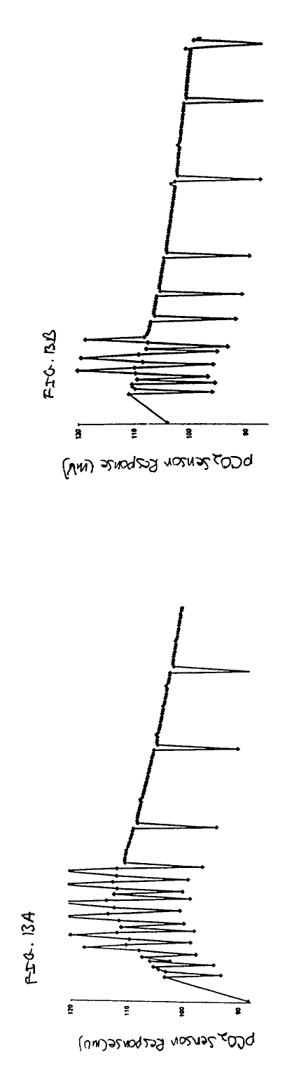

Studies were performed to assess the effect of thermal cycled versus non-thermal cycled sensors on hydration and calibration time of Na⁺, K⁺, Ca⁺⁺, pH and pCO₂ sensors. The results are graphically represented for non-thermal cycled sensors in FIGS. 9A, 10A, 11A, 12A, and 13A, and for thermal cycled sensors in FIGS. 9B, 10B, 11B, 12B, and 13B, for Na⁺, K⁺, Ca⁺⁺, pH and CO₂ sensors, respectively. Over 300 test samples were analyzed for each sensor card. Non-thermal cycled sensors were warmed in calibrating solution for 30 minutes at 37° C., and thermal-cycled sensors were warmed in calibrating solution for 30 minutes at 60° C., before initiating the calibration procedure. For each type of ion sensor, out-of-warm up period baseline drift is significantly reduced for sensors thermal cycled to 60° C. for 30 minutes compared to non-thermal cycled sensors. The advantages of accelerated hydration through thermal cycling are: reduced drift and slope failures out-of-the warm-up period, improved quality control, and reduced warm-up period.

What is claimed is:

1. A method for rapidly hydrating a sensor, comprising:
(a) providing the sensor;
(b) contacting the sensor with a calibrating solution;
(c) exposing the sensor and the calibrating solution to an elevated temperature for a time period less than or equal to about 15 minutes; and
(d) exposing the sensor and the calibrating solution to a lower temperature less than the elevated temperature.

2. The method of claim 1 wherein the sensor of step (a) comprises a dry chemical sensor.

3. The method of claim 1 wherein the sensor of step (a) comprises an enzyme sensor.

4. The method of claim 1 wherein the sensor of step (a) comprises an electrochemical sensor.

5. The method of claim 1 wherein step (c) comprises exposing the sensor and the calibrating solution to the elevated temperature which is in the range of about 55° C. to 75° C.

6. The method of claim 1 wherein step (d) comprises exposing the sensor and the calibrating solution to the lower temperature which is in the range of about 15° C. to about 45° C.

7. The method of claim 6 wherein step (d) further comprises exposing the sensor and the calibrating solution to the lower temperature which is about 37° C.

8. The method of claim 1 wherein step (b) comprises contacting the sensor with the calibrating solution which comprises an electrolyte solution.

9. The method of claim I wherein step (c) comprises exposing the sensor and the calibrating solution to the elevated temperature of 65° C. for a time period of 12 minutes and wherein step (d) comprises exposing the sensor and the calibrating solution to the lowered temperature of 37° C. for 16-18 minutes.

10. A system for rapid hydration of a sensor, comprising:
the sensor;
a calibrating solution in contact with the sensor; and
a heating mechanism for heating the sensor and the calibrating solution to an elevated temperature for a first time period less than or equal to about 15 minutes.

11. The system of claim 10 wherein the heating mechanism also lowers the elevated temperature after the time period to expose the sensor and the calibrating solution to a lower temperature less than the elevated temperature.

12. The system of claim 10 wherein the sensor comprises a dry chemical sensor.

13. The system of claim 10 wherein the sensor comprises an electrochemical sensor.

14. The system of claim 10 wherein the sensor comprises an enzyme sensor.

15. The system of claim 10 wherein the heating mechanism heats the sensor and the contacting electrolyte solution to the elevated temperature which is 65° C.

16. The system of claim 11 wherein the heating mechanism lowers the elevated temperature to expose the sensor and the contacting electrolyte solution to the lower temperature which is 37° C.

17. The system of claim 10 wherein the electrolyte solution comprises a calibrating solution.

18. The system of claim 11 wherein the elevated temperature is 65° C. and the time period for heating the sensor at the elevated temperature is 12 minutes and the lower temperature is 37° C. and the time period for exposing the sensor at the lower temperature is 16-18 minutes.
